(19) United States
(12) Patent Application Publication
(10) Pub. No.: US 2002/0124680 A1
(43) Pub. Date: Sep. 12, 2002

(54) Adjustable throttle stop collar

(76) Inventor: Christopher Lee Sjodin, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 09/801,824

(22) Filed: Mar. 9, 2001

(51) Int. Cl. G05G 1/04

(52) U.S. Cl. 74/526

(57) ABSTRACT

A throttle stop collar for a manually-operated throttle lever includes a resilient ring defining a cylindrical cavity therethrough, the ring sized for snug sliding fitment over a handlebar handgrip. The ring has an outer surface eccentrically disposed relative to the cylindrical cavity. The ring is sized to fit between the throttle lever and the handlebar in a path of the throttle lever when depressed by a user so as to selectively obstruct and limit a range of motion of the throttle lever when rotated between a closed-throttle idle position and an open throttle position.

### FIELD OF THE INVENTION

This invention relates to the field of safety devices for hand control throttles, and in particular, to a ring or collar for adjustable control of the range of motion of a manually actuated throttle lever.

### BACKGROUND OF THE INVENTION

As documented in U.S. Pat. No. 4,570,593 which issued Feb. 18, 1986 to Take et al for a Throttle Safety Device, it is known in the prior art to lock-out the use of a throttle trigger so as to prevent irregular operation due to the operator inadvertently touching and moving the throttle trigger. Thus as taught by Take et al a prior art throttle trigger lock-out device includes a coil spring to resiliently urge a locking member into an operative position. What is neither taught nor suggested, and what it is an object of the present invention to provide, is spirally, or otherwise eccentrically or irregularly-shaped collar which allows the incremental adjustment of the available range of motion of a throttle trigger or lever. The device provides for incremental adjustment rather than the lock-out of Take et al in which the throttle trigger is either entirely locked-out to prohibit any range of motion, or entirely unlocked to allow entirely free range of motion.

### SUMMARY OF THE INVENTION

The adjustable throttle stop collar of the present invention for use in cooperation with a manually-operated throttle lever includes a resilient ring defining a cylindrical ring cavity therethrough. The ring cavity is sized for snug sliding fitment over a handlebar handgrip of a personal recreational craft such as a snowmobile or personal watercraft. The ring has an outer surface eccentrically, such as spirally, disposed relative to the cylindrical cavity. The ring is sized to fit between the throttle lever and the handlebar in a path of the throttle lever when depressed by a user so as to selectively obstruct and limit a range of motion of the throttle lever when rotated between a closed-throttle idle position and an open throttle position. In one embodiment of the invention, the outer surface of the ring is formed as a spiral extending radially around the outer surface of the ring between a minimum ring height position, wherein a ring height between the cylindrical cavity and the outer surface of the ring is a minimum, and a maximum ring height position wherein the ring height is a maximum. The maximum ring height position is radially spaced from the minimum ring height position around the outer surface of the ring. Where the spiral is a single spiral and the ring height smoothly increases around the spiral, the minimum and maximum ring height positions are adjacent and separated only by a notch.

In one embodiment, not intended to be limiting, the ring has a substantially uniform thickness measured perpendicular to the ring height, that is, measured parallel to the longitudinal axis of the handle when the ring is mounted on the handle. The thickness may, although not necessarily, be generally equal to an average height of the ring, that is, the dimension of the ring between the cylindrical cavity and the outer surface. Thus, the maximum ring height may be greater than the thickness of the ring, and the minimum ring height may be less than the thickness of the ring.

### BRIEF DESCRIPTION OF THE DRAWINGS

FIG. 1 is, in side perspective view, the throttle stop collar of the present invention installed onto a handlebar of a personal recreational vehicle or watercraft.

FIG. 2 is the view of FIG. 1 in rear perspective view.

FIG. 3 is, in side elevation view, the throttle stop collar of FIG. 1.

FIG. 4 is the throttle stop collar of FIG. 3 in front elevation view.

### DETAILED DESCRIPTION OF EMBODIMENTS OF THE INVENTION

There are on the market today personal recreational vehicles and watercraft such as personal watercraft for example sold under the trademark Sea-Doo, and snowmobiles such as sold under the trademark Ski-Doo which employ thumb-operated throttle levers or triggers to control and regulate engine speed. Collectively referred to herein as craft, these craft may be relatively powerful and capable of rapid acceleration, which in the hands of an inexperienced user may be potentially dangerous given the environment in which these craft are operated.

Thus it would be desirable to have a simple-to-use and inexpensive means of selectively adjusting the available range of motion of the thumb operated lever or trigger so as to tailor the amount of available acceleration to a specific user. Thus a more inexperienced or young user of such personal craft will have available to them only such levels of mild acceleration suitable for training. It is desirable, and an object of the present invention to provide, that as the user gains more experience or becomes more physically able with age, that the available acceleration may be increased by allowing incrementally an increased range of motion of the thumb operated throttle lever or trigger.

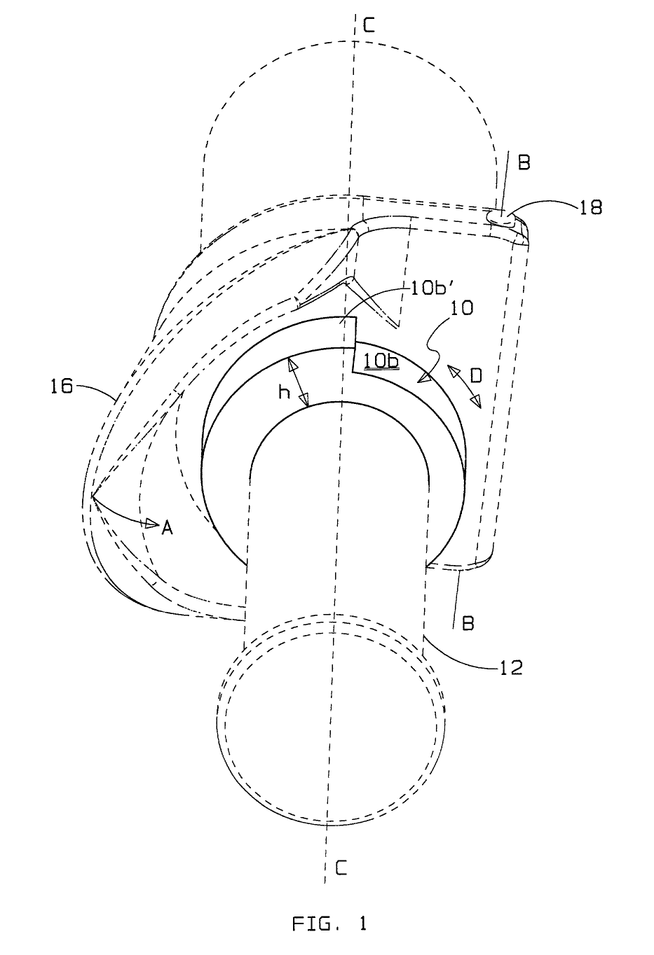

Thus as seen in FIGS. 1-4, in one preferred embodiment of the present invention, an eccentric collar 10 is provided for mounting onto, or adjacent a hand grip 12 on a handle bar 14 so as to be disposed between thumb operated throttle lever 16 and either handlebar 14 or hand grip 12. Throttle lever 16 is operated by the thumb of a user (shown in dotted outline) pivoting throttle lever 16 in direction A about axis B against the resilient return biasing force acting on the lever as well known in the art.

In conventional operation, the user accelerates the personal craft by holding handgrip 12 in the palm of the hand while simultaneously manually depressing throttle lever 16 in direction A. Depressing throttle lever 16 in direction A rotates the throttle lever about axis of rotation B on pins or shaft 18. Manual operation is illustrated as use of the user's thumb, but this is not intended to be limiting as manual operation is intended to include operation by any digit.

Collar 10 is made of material such that collar 10 is pliable, flexible, and resilient without hysteresis so as to return to its non-deformed state once throttle pressure from the throttle lever is released. Further, collar 10 or at least its inner surface may have a tackiness, for example if it is made of a polymer material, so as to enhance a friction fit on the hand grip or handle bar.

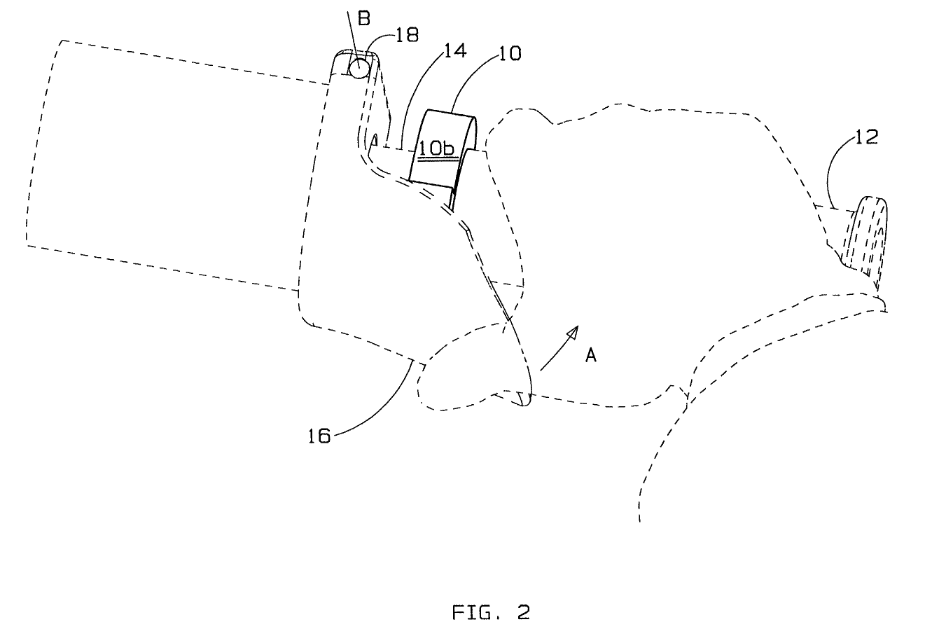

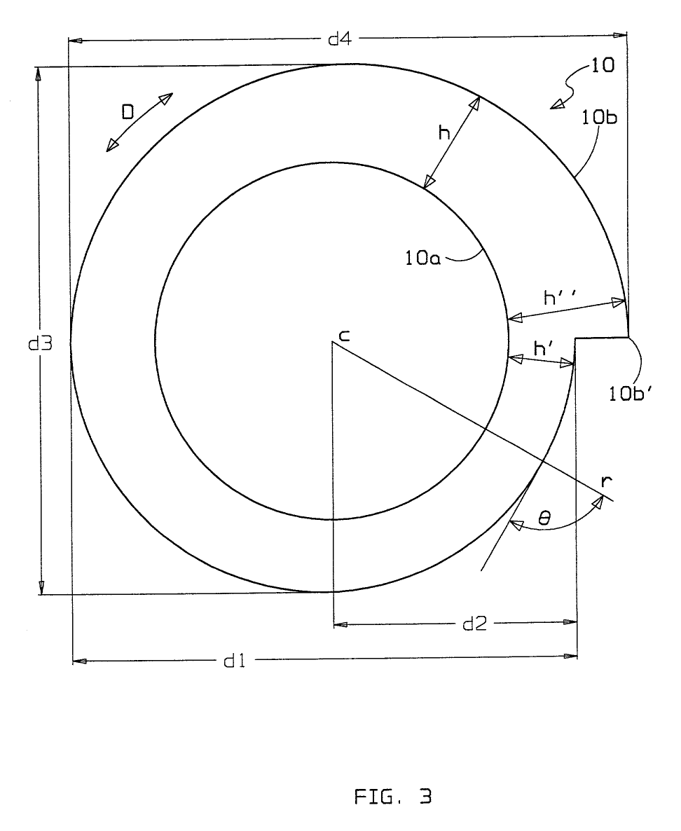

Collar 10 is slipped over handgrip 12 and, even though a snug friction fit thereover, collar 10 because of its resilient composition may be slid, for example by an oscillatory corkscrew motion, along handgrip 12 into a position so as to obstruct the full range of motion of the throttle lever when rotated in direction A. The available range of motion for rotation of throttle lever 16 is therefore dictated by the size of the obstruction presented by collar 10 and, in particular, by the height “h” of collar 10, where height “h” is the distance along a radial line perpendicular to handle bar axis C between inner surface 10a and outer surface 10b of collar 10. Surface 10a is cylindrical. Surface 10b when viewed in side elevation as seen in FIG. 3, that is, in a plane perpendicular to axis C when collar 10 is in use as seen in FIGS. 1 and 2, forms a spiral relative to surface 10a so that height h′, where surface 10b is closest to surface 10a, is significantly less than height h″ where surface 10b is the greatest distance from surface 10a.

Without intending to be limiting, the spiral formed by surface 10b need not conform to one particular form of spiral, for example, a logarithmic or equi-angular spiral wherein angle θ (the angle between the tangent to the curve and radial line r where the two intersect) remains constant as radial line r sweeps out the entire arc as height h increases gradually from height h′ to height h″. In alternative embodiments, surface 10b does not necessarily have to be a gradually increasing spiral surface relative to center “c” but may undulate or otherwise provide for irregular heights h so long as rotation of collar 10 in direction D allows for collar 10 to be angularly preset so as to adjust the amount of the obstruction, that is, the particular height h of collar 10 which is deliberately advanced so as to obstruct the trajectory of trigger lever 16 as it is rotated in direction A about axis B.

Thus in the embodiment illustrated, for a novice or young user of the personal craft where it is desirable to allow only a small amount of acceleration, collar 10 is rotated so as to position peak 10b′ so as to minimize the available range of rotational motion of trigger lever 16. This would normally mean rotating peak 10b′ to a position beneath where trigger lever 16 would first contact hand grip 12 or handlebar 14 were it not for the presence of collar 10.

Conversely, where the user is more experienced or older, peak 10b′ is rotated out of the way so as to, for example, position the portion of surface 10b corresponding to height h′ beneath trigger lever 16 so as to allow an increased range of motion and commensurate increased acceleration available to the user.

In between these two extremes, rotation of collar 10 allows for incremental adjustment of the available range of motion and commensurate acceleration to a user. The snug frictional fit of resilient collar 10 onto handgrip 12 allows for presetting of the rotational orientation of collar 10 and for retaining collar 10 in that spatial orientation during use. The snug frictional fit of collar 10 resists the vibration of the handlebar which might cause collar 10 to rotate out of its desired position.

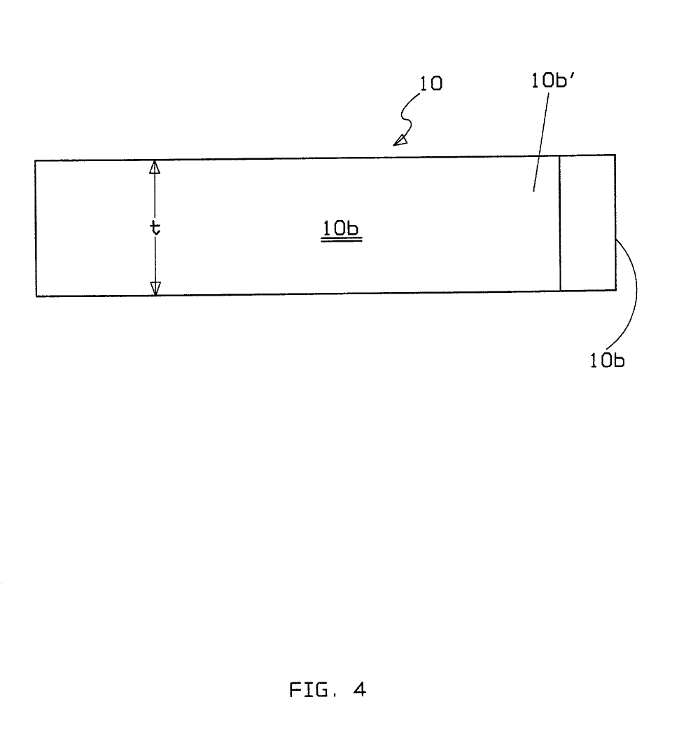

In preferred embodiment, thickness “t” as seen in FIG. 4 may be 0.50 inches. In that preferred embodiment, without intending to be limiting, the diameter of the cylindrical cavity defined by surface 10a may be 1.125 inches. Dimension d₁ may be approximately 1.94 inches, dimension d₂ may be approximately 0.87 inches, dimension d₃ may be approximately 2.1 inches and dimension d₄ may be approximately 2.3 inches. In this manner, collar 10 will snugly fit on to at least some of the handgrips 12 of which applicant is aware and will provide for the eccentric relationship between surfaces 10a and 10b which provide the aforementioned advantages. A person skilled in the art would know to make the required adjustments to the aforesaid dimensions to accommodate different sized handgrips 12.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A throttle stop collar for a manually-operated throttle lever comprising
a resilient ring defining a cylindrical cavity therethrough sized for snug sliding fitment over a handlebar handgrip,
said ring having an outer surface eccentrically disposed relative to said cylindrical cavity, said ring sized to fit between said throttle lever and said handlebar in a path of said throttle lever when depressed by a user so as to selectively obstruct and limit a range of motion of said throttle lever when rotated between a closed-throttle idle position and an open throttle position.

2. The throttle stop collar of claim 1 wherein said outer surface of said ring is formed as a spiral extending radially around said outer surface between a minimum ring height position, wherein a ring height between said cylindrical cavity and said outer surface of said ring is a minimum, and a maximum ring height position wherein said ring height is a maximum radially spaced form said minimum ring height position.

3. The throttle stop collar of claim 2 wherein said minimum and maximum ring height positions are adjacent and said spiral is a single spiral and said ring height smoothly increases around said spiral.

4. The throttle stop collar of claim 1 wherein said ring has a substantially uniform thickness measured perpendicular to said ring height, and said thickness is generally equal to an average height of said ring between said cylindrical cavity and said outer surface.

5. The throttle stop collar of claim 2 wherein said ring has a substantially uniform thickness measured perpendicular to said ring height.

6. The throttle stop collar of claim 2 wherein said maximum ring height is greater than a thickness of said ring, and said minimum ring height is less than said thickness of said ring.

7. The throttle stop collar of claim 5 wherein said maximum ring height is greater than said thickness of said ring and wherein said minimum ring height is less than said thickness of said ring.

8. The throttle stop collar of claim 3 wherein said maximum ring height is greater than said thickness of said ring and wherein said minimum ring height is less than said thickness of said ring.
